(19) United States
(12) Patent Application Publication
(10) Pub. No.: US 2025/0373648 A1
(43) Pub. Date: Dec. 4, 2025

(54) REMOTE ACCESS SESSION MONITORING TECHNIQUES

(71) Applicant: Honeywell International Inc., Charlotte, NC (US)

(72) Inventors: Atul Bassi, BANGALORE (IN); Eli Abramson, Rishon LeTsiyon (IL); Nagarjuna Reddy Chevuru, Bangalore (IN); Tarun Gupta, Bangalore (IN)

(21) Appl. No.: 18/676,478

(22) Filed: May 28, 2024

(51) Int. Cl. H04L 9/40; G06F 11/34; H04L 67/50

(52) U.S. Cl. CPC H04L 63/1441; G06F 11/3438; H04L 63/1425; H04L 67/535

(57) ABSTRACT

Approaches for monitoring a remote access session are described. According to one example, user activity data may be received and processed to ascertain occurrence of an unfamiliar activity event during the remote access session. The user activity data may be indicative of actions executed by a particular user at a user device during the remote access session that is established for remotely accessing an operational technology (OT) network at an organizational site for performing a particular activity. The user activity data may be processed by implementing an activity monitoring model. The unfamiliar activity event may have no association to the particular activity. Upon ascertaining occurrence of the unfamiliar activity event, one or more preventive actions may be initiated. For example, an alert notification may be generated for transmission to a supervisor. Further, immediate termination of the remote access session may be initiated.

### BACKGROUND

With large scale digitalization, most industrial processes are being automated to enable remote management, thereby, enhancing operational efficiency. For such remote management, users are allowed to remotely access an operational technology (OT) network of an organization for carrying out various activities, such as maintenance activities in an industrial control system (ICS) of the OT network. For example, organizations may allow external vendors to access equipment installed in the organizations for routine or unplanned maintenance activities, such as patching, hardening, and log collection, as well as for performing investigations into a sudden drop in production, or a potential cyber-security breach. Thus, remote access enables the industries to carry out more efficient operations and businesses. However, enabling remote access of the OT network may expose the organization, specifically the OT network to external cyber-security risks that may compromise the safety and reliability of the industrial processes being accessed or controlled using the OT network.

### BRIEF DESCRIPTION OF FIGURES

Systems and/or methods are now described, in accordance with examples of the present subject matter and with reference to the accompanying figures, in which:

FIG. 1 illustrates a communication environment implementing a system for monitoring a remote access session, according to an example;

FIG. 2A and FIG. 2B illustrate a communication environment implementing the system for monitoring a remote access session, according to another example;

FIG. 3 illustrates a simplified block diagram illustrating communication links between various components of the computing environment of FIG. 2A and FIG. 2B during monitoring of a remote access session, according to an example;

FIG. 4 illustrates a method for monitoring a remote access session, according to an example;

FIG. 5A illustrates a method for training of a machine learning model for detecting unfamiliar user activities during a remote access session, according to an example;

FIG. 5B illustrates a method for training of a machine learning model for detecting malicious user activities during a remote access session, according to an example;

FIG. 6 illustrates a method for monitoring a remote access session, according to another example; and

FIG. 7 illustrates a computing environment implementing a non-transitory computer-readable medium for monitoring a remote access session, according to an example.

### DETAILED DESCRIPTION

Typically, for the purpose of monitoring, managing, and streamlining operations or performing activities, such as maintenance in relation to variety of assets within an OT network at an organizational site, users may remotely access the OT network through commercially available remote equipment access platforms. Such remote equipment access platforms allow users to remotely access the OT network by establishing a remote access session. The remote access session may be established by users for a pre-defined time period. Such remote equipment access platforms also enable screen recording of the remote access session.

Typically, for a remote access session established by a particular user for a particular time period to remotely access the OT network, a screen recording of user actions performed by the particular user during the remote access session may be obtained. A supervisor working for the organization may monitor or scan the screen recording either in real-time or whenever any undesired event occurs. The user actions during the remote access session may be monitored in real-time to monitor if the user is performing any unauthorized activity. For real-time monitoring of the user actions during the remote access session, a dedicated supervisor may be required to be allocated for each remote access session. Further, whenever any undesired event occurs at an organizational site, the supervisor investigates the recording to find out unauthorized activities that caused such undesirable event to occur.

In order to find out the cause of the undesired event, the supervisors are required to go through recordings of all the remote access sessions that were established during some time-period prior to the undesired event. For example, in case of a fire at an organizational site, the supervisors may be required to go through recordings of all the remote access sessions that were established by various users during the last week prior to the fire.

Manually going through the recordings is a time consuming and a tedious task, thereby being an inefficient process of monitoring the user actions during the remote access sessions. Further, most of the time spent by the supervisor is wasted as the unauthorized activity may be performed by the user in some part of one of the remote access sessions monitored by the supervisor. Moreover, there are high chances that a supervisor may miss the unauthorized activity while going through the recordings, for example, due to long remote access sessions, change in shift of the supervisor, supervisor being engaged in another prioritized activity, or any emergency in the organization. In such a case, the supervisor may be required to go through the recordings again. This may lead to wastage of manual and processing resources that are consumed while going through the recordings of the remote access sessions. The problem may further escalate as the number of remote access sessions increases. For example, in the week prior to the fire, twenty five different users may have remotely accessed the OT network for six hours each. Thus, a supervisor would be required to go through one hundred and fifty hours of recordings to find out the cause of the fire. Further, during real-time monitoring of the recordings, ten different dedicated supervisors may be required just to monitor the user actions, if simultaneously ten users are remotely accessing the OT network.

Due to high dependency on the supervisor, such traditional techniques are highly inefficient in finding out malicious activities, thereby leading to a high probability of a malicious user successfully implementing a malicious activity in the OT network.

Malicious activities directed at systems or devices within the OT networks may result in an unauthorized access of critical industrial data, data breaches, interruption of crucial processes, and monetary losses. Inefficient cybersecurity for the OT network of an organization may thus result in undesired operational disruptions, system failures, and downtime, thereby leading to severe consequences, including production delays, decreased efficiency of the OT network, reputational damage for the organization, and financial losses for the organization.

Inadequate OT cybersecurity may further cause safety risks to employees of the organization, the public, and the environment. For example, cyber-attacks targeting the OT network in industries, such as manufacturing, energy, and transportation, may potentially lead to dangerous accidents, equipment malfunctions, or environmental disasters, thus jeopardizing human lives and causing significant damage to the environment and the organization's infrastructure. Such accidents or disasters may even lead to non-compliance of standard regulations due to which the organization may suffer regulatory penalties, legal repercussions, and reputational harm. Inefficient cybersecurity for the OT network may put the organization at a competitive disadvantage due to lack of trust in customers, partners, and other stakeholders.

Further, once the security of the OT network is breached, addressing vulnerabilities in the OT cybersecurity may be expensive. For example, the organization may need to cover expenses for the loss in productivity due to the downtime, court costs, fines, customer compensation, and damage control costs. Therefore, there is a need for efficient security measures which can prevent cyber-attacks on the OT networks.

Approaches for monitoring a remote access session are described. The present subject matter facilitates an automated and efficient detection of malicious or unfamiliar activities performed by a user during a remote access session. The remote access session may be established for remotely accessing an operational technology (OT) network at an organizational site for performing a particular activity. For detecting a malicious activity, user activity data, indicative of actions executed by a particular user at a user device during the remote access session, may be recorded. In one example, the user activity data may be monitored and processed, either in real-time or at a later time, using an activity monitoring model to ascertain occurrence of an unfamiliar activity event during the remote access session. The unfamiliar activity event may have no association to the particular activity. Upon ascertaining occurrence of the unfamiliar activity event during the remote access session, one or more preventive actions, such as immediate termination of the remote access session or alert notification generation may be initiated. The described approaches thus provide a simple and robust analytical methodology for early, quick, efficient, and automated detection of unfamiliar activities that may be malicious. The described approaches are not dependent on a supervisor and may also be able to efficiently monitor digital activities, such as transfer of files and access to shared drives, which are otherwise not visible to a human.

In an example, the activity monitoring model may be initially trained using historical ideal user activity data. The historical ideal user activity data may be indicative of different ideal user actions that are usually taken by users for performing the particular activity. The different ideal user actions may, for example, include actions that are typically performed by an authentic user for performing the particular activity. Subsequently, the historical ideal user activity data may be analyzed to obtain the activity monitoring model.

In an example, malicious user activities other than the unfamiliar user activities may also be detected and appropriate measure may accordingly be taken upon detection of the malicious user activities. In one example, for detecting malicious user activities, a malicious activity detection model may be trained and used. For training the malicious activity detection model, pre-defined malicious user activity data may be obtained. The pre-defined malicious user activity data may be indicative of different malicious user actions performable during the remote access session. Subsequently, the pre-defined malicious user activity data may be analyzed to obtain the malicious activity detection model. The malicious activity detection model may then be implemented to analyze the user activity data to ascertain occurrence of a malicious activity event during the remote access session. The malicious activity event may include occurrence of at least one of the malicious user actions during the remote access session.

Upon ascertaining occurrence of the malicious activity event during the remote access session, one or more preventive actions may be initiated. For example, an alert notification may be generated for transmission to a supervisor on a supervisor device. Further, during real-time monitoring of the user activity data, immediate termination of the remote access session may be initiated.

Since the activity monitoring model is obtained through training on the historical ideal user activity data, the described approaches may easily identify unfamiliar user actions by identifying that a particular user action is not typically performed while performing the particular activity. Further, since the malicious activity detection model is obtained through training on the pre-defined malicious user activity data, the described approaches may easily identify whether a particular user action is malicious or not.

Further, according to the described approaches, not only screen recording of the remote access session but also other user actions recorded in terms of digital signals can be monitored to find if any user action being performed during the remote access session is unfamiliar or malicious. Thus, the described approaches enable early, quick, efficient, and automated detection of unfamiliar and malicious activities. The described approaches do not require dedicated human resources and eliminate the risk of any unfamiliar or malicious activity being missed. The described approaches further eliminate wastage of manual and processing resources that are otherwise conventionally consumed while the supervisor goes through the recordings of the remote access sessions. Upon efficiently and accurately finding unfamiliar or malicious user actions, the described approaches enable appropriate measures to be initiated for countering the effect of the unfamiliar or malicious user activity. As a result, occurrence of any undesired event due to the unfamiliar or malicious activity can be prevented, and the organization may be prevented from safety hazards and covering expenses which would have otherwise been required to be covered in case of any undesired event.

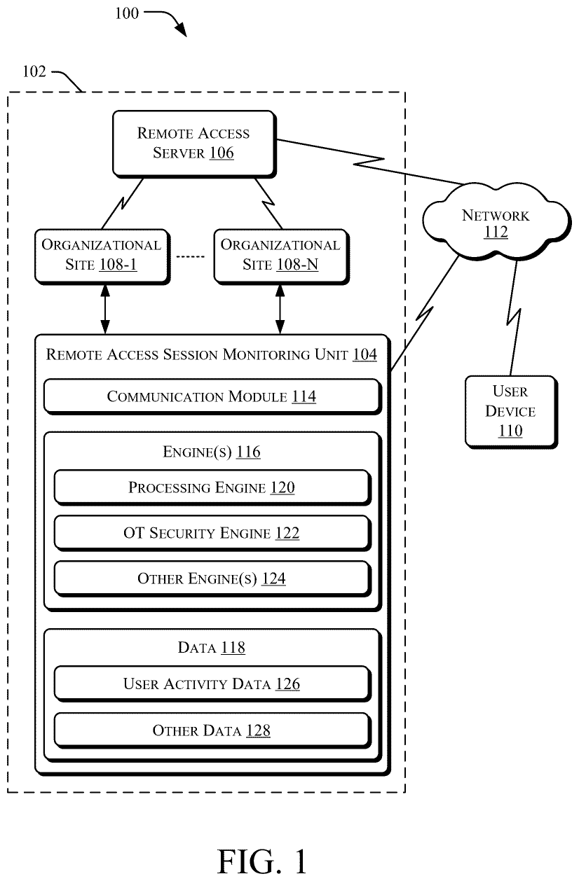

The present subject matter is further described with reference to FIG. 1 to FIG. 7. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a communication environment 100 implementing a system 102 for monitoring a remote access session, according to an example. The remote access session may be a session established by a user for remotely accessing an asset, such as hardware equipment or software applications, within an operational technology (OT) network of an organization. In an example, the system 102 may include a remote access session monitoring unit 104 and a remote access server 106. In an example, the system 102 may further include one or more organizational sites 108-1 to 108-N, where N is a natural number. The one or more organizational sites 108-1 to 108-N may be individually referred to as organizational site 108 and collectively referred to as organizational sites 108. In one example, the system 102 may be a distributed computing system having one or more physical computing systems geographically distributed at same or different locations. In another example, one or more components of the system 102 may be hosted virtually, for example, on a cloud-based platform, while other components may be co-located with each other.

The remote access session monitoring unit 104 may be configured to monitor actions performed by a user during the remote access session to detect any unfamiliar or malicious user activity. Upon detecting any unfamiliar or malicious user activity, the remote access session monitoring unit 104 may be configured to implement one or more preventive measures for countering the effects of such unfamiliar or malicious user activity. The remote access server 106 may be configured to enable the user to establish the remote access session to remotely access the OT network of the organization. In an example, the remote access server 106 may be configured to host a remote equipment access platform. The remote equipment access platform may allow the user to select the organizational site 108 as well as the asset within the OT network at the organizational site 108 that the user aims to remotely access. The organizational site 108 may be a site, belonging to the organization, at which various assets of the organization are located. For example, a power generation plant may be an organizational site 108 having plant servers and assets, such as power generators, motors, sensors, and a control system for controlling the operations of various components at the power generation plant.

The computing environment 100 may include the system 102 and a user device 110. The user device 110 may be operated by a user to remotely access the OT network of the organization through the remote access server 106. Examples of the user device 110 may include, but are not limited to, a laptop, a desktop, a tablet computer, and a smart phone. In an example, a version of the remote equipment access platform may be accessed through the user device 110 by way of a website or a software application, enabling the user to gain remote access to the OT network.

The remote access session monitoring unit 104, the remote access server 106, and the user device 110 may be communicably coupled with each other over a network 112 and may exchange data and signals over the network 112. The network 112 may be a wireless network, a wired network, or a combination thereof. The network 112 may also be an individual network or a collection of many such individual networks, interconnected with each other and functioning as a single large network, e.g., the Internet or an intranet. Examples of such individual networks include, but are not limited to, local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the network 112 may include various network entities, such as transceivers, gateways, and routers. In an example, the network 112 may include any communication network that uses any of the commonly used protocols, for example, Hypertext Transfer Protocol (HTTP), and Transmission Control Protocol/Internet Protocol (TCP/IP).

In one example, the remote access server 106 and the remote access session monitoring unit 104 may be communicably coupled with the organizational site 108 through a wired or a wireless connection for the purpose of exchanging data and signals. Although the remote access server 106 and the remote access session monitoring unit 104 have been illustrated to have a direct connection with the organizational site 108, it should be understood that the remote access server 106 and the remote access session monitoring unit 104 may be communicably coupled with the organizational site 108 over the network 112.

The remote access session monitoring unit 104 may include a communication module 114, engine(s) 116, and data 118. The remote access session monitoring unit 104 may also include components, other than the depicted components, such as display, input/output interfaces, operating systems, applications, and other software or hardware components (not shown in the figures).

The communication module 114 may be a wireless communication module. Examples of the communication module 114 may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication module 114 may also include one or more antennas to enable wireless transmission and reception of data and signals.

The engine(s) 116 may be implemented as a combination of hardware and programming, for example, programmable instructions to implement a variety of functionalities of the engine(s) 116. In examples described herein, such combinations of hardware and programming may be implemented in several different ways. For example, the programming for the engine(s) 116 may be executable instructions. Such instructions may be stored on a non-transitory machine-readable storage medium which may be coupled either directly with the remote access session monitoring unit 104 or indirectly (for example, through networked means). In an example, the engine(s) 116 may include a processing resource, for example, either a single processor or a combination of multiple processors, to execute such instructions. In the present examples, the non-transitory machine-readable storage medium may store instructions that, when executed by the processing resource, implement engine(s) 116. In other examples, the engine(s) 116 may be implemented as electronic circuitry.

In one example, the engine(s) 116 may include a processing engine 120, an OT security engine 122, and other engine(s) 124. The other engine(s) 124 may further implement functionalities that supplement functions performed by the remote access session monitoring unit 104 or any of the engine(s) 116.

The data 118 may include data that is either received, stored, or generated as a result of functions implemented by any of the engine(s) 116 or the remote access session monitoring unit 104. It may be further noted that information stored and available in the data 118 may be utilized by the engine(s) 116 for performing various functions by the remote access session monitoring unit 104. The data 118 may include user activity data 126 and other data 128. In an example, the user activity data 126 may be received from the remote access server 106. The user activity data 126 may be user actions recorded by the remote access server 106 during the remote access session. The other data 128 may include data that is either received, stored, or generated as a result of functions implemented by any of the engine(s) 116 or the remote access session monitoring unit 104.

In operation, when a remote access session is established by a particular user, through the user device 110, to remotely access an operational technology (OT) network at the organizational site 108 for performing a particular activity, the remote access server 106 may record actions executed at the user device 110 during the remote access session. Examples of the particular activity may include, but are not limited to, investigation procedure for looking into a sudden drop in production, investigation procedure for looking into a potential cyber-security breach, and routine maintenance or unplanned activities such as such as patching, hardening and log collection. The remote access server 106 may compile the user actions into user activity data. Thus, the user activity data may be indicative of the actions executed at the user device 110 during the remote access session. Examples of the actions executed at the user device 110 may include, but are not limited to, movement of a mouse locally on the user device 110, keystrokes pressed on a keyboard of the user device 110, and transfer of files between the user device 110 and the OT network. The remote access server 106 may then transmit the user activity data to the remote access session monitoring unit 104.

The communication module 114 of the remote access session monitoring unit 104 may receive the user activity data recorded in relation to the remote access session. In an example, the user activity data may be received in the form of digital signals.

Subsequently, the processing engine 120 of the remote access session monitoring unit 104 may implement an activity monitoring model to process the user activity data. The user activity data may be processed to ascertain occurrence of an unfamiliar activity event during the remote access session. The unfamiliar activity event may have no association to the particular activity. For example, if the particular user has established the remote access session for performing patching for a software, the activity monitoring model may be able to detect if the particular user performs any action that is not typically performed while performing patching. In an example, the user activity data may be received and processed in real-time while the actions are being performed during the remote access session. In another example, the user activity data may be received and processed at a later time after the actions have been performed.

Upon ascertaining occurrence of the unfamiliar activity event during the remote access session, the OT security engine 122 of the remote access session monitoring unit 104 may initiate one or more preventive actions. In an example, one preventive action can be to generate an alert notification for transmission to a supervisor on a supervisor device so that the supervisor can take an appropriate measure for countering the effect of the unfamiliar activity event. During real-time monitoring of the user activity data, an exemplary preventive action may be initiating immediate termination of the remote access session. Immediate termination of the remote access session inhibits the particular user from executing any further unfamiliar or malicious actions within the OT network. Thus, the remote access session monitoring unit 104 may efficiently and quickly detect unfamiliar activities that may be malicious and prevent the OT network from a cyber-attack.

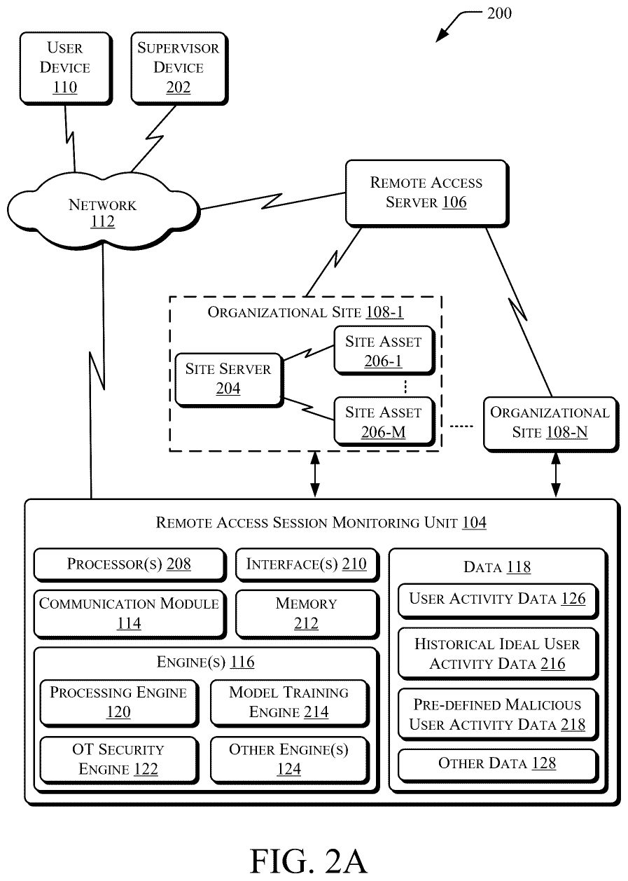

FIG. 2A and FIG. 2B illustrate a communication environment 200 implementing the system 102 for monitoring a remote access session, according to another example. Although the system 102 has not been illustrated explicitly in FIG. 2A and FIG. 2B, it is to be understood that the remote access session monitoring unit 104, the remote access server 106, and the organizational site 108 are a part of the system 102, as explained with reference to FIG. 1. In one example, the computing environment 200 may include the remote access session monitoring unit 104, the remote access server 106, the organizational site 108, the user device 110, and a supervisor device 202. The supervisor device 202 may be communicably coupled with other components of the communication environment 200 over the network 112. The supervisor device 202 may be accessed by a supervisor associated with a particular organization. In an example, the supervisor may access the supervisor device 202 to receive alerts regarding malicious or unfamiliar activities performed during the remote access session for the particular organization. As exemplarily illustrated in FIG. 2B, examples of the user device 110 may include, but are not limited to, a laptop 110-1 and a mobile phone 110-2. As exemplarily illustrated in FIG. 2B, examples of the supervisor device 202 may include, but are not limited to, a laptop 202-1 and a mobile phone 202-2. Examples of the user device 110 and supervisor device 202 may also include, but are not limited to, a desktop, a tablet computer, and any electronic device capable of transmitting or receiving data.

In an example, the organizational site 108 may include a site server 204 and one or more site assets 206-1 to 206-M, where M is a natural number. The one or more site assets 206-1 to 206-M may be individually referred to as site asset 206 and collectively referred to as site assets 206. The site server 204 and the site asset 206 may be communicably coupled with each other through a wired or a wireless connection for the purpose of exchanging data and signals. The site server 204 and the site assets 206 may together form an OT network of an organization at the organizational site 108. The organizational sites 108 may belong to a same organization or different organizations. The site server 204 may store and manage data associated with the organization and the site assets 206. The site assets 206 may be utilized by the organization for implementing various industrial processes.

As exemplarily illustrated in FIG. 2B, examples of the site assets 206 may include, but are not limited to, a sensor 206-1, a computer 206-2, a printing machine 206-3, and a camera 206-4. The sensor 206-1 may be any type of sensor such as a temperature sensor and a pressure sensor. Although only hardware components have been illustrated as the site assets 206 in FIG. 2B, it should be understood that the site assets 206 may also include software assets utilized by the organization for implementing various industrial processes.

In one example, the remote access session monitoring unit 104 may include processor(s) 208, interface(s) 210, memory 212, the communication module 114, the engine(s) 116, and the data 118. The remote access session monitoring unit 104 may include components, other than the depicted components, such as display, input/output interfaces, operating systems, applications, and other software or hardware components (not shown in the figures).

The processor(s) 208 may be implemented as microprocessors, microcomputers, microcontrollers, digital signal processors, central processing units, state machines, logic circuitries, and/or other devices that manipulate signals based on operational instructions. The interface(s) 210 may allow the connection or coupling of the remote access session monitoring unit 104 with one or more other devices, such as the remote access server 106 and the site server 204 of the organizational site 108, through a wired (e.g., Local Area Network, i.e., LAN) connection or through a wireless connection (e.g., Bluetooth®, Wi-Fi). The interface(s) 210 may also enable intercommunication between different logical as well as hardware components of the remote access session monitoring unit 104.

The memory 212 may be a computer-readable medium, examples of which include volatile memory (e.g., RAM), and/or non-volatile memory (e.g., Erasable Programmable read-only memory, i.e., EPROM, flash memory, etc.). The memory 212 may be an external memory, or internal memory, such as a flash drive, a compact disk drive, an external hard disk drive, or the like. The memory 212 may further include the data 118 and/or other data which either may be received, utilized, or generated during the operation of the remote access session monitoring unit 104.

In one example, the engine(s) 116 may include the processing engine 120, the OT security engine 122, and the other engine(s) 124, as explained with reference to FIG. 1. In an example, the engine(s) 116 may further include a model training engine 214.

The data 118 may include the user activity data 126 and the other data 128, as explained with reference to FIG. 1. In an example, the data 118 may further include historical ideal user activity data 216 and pre-defined malicious user activity data 218. In an example, the historical ideal user activity data 216 may be received from the remote access server 106. The historical ideal user activity data 216 may be historical data including ideal user actions executed by authentic users while performing different activities for which historical remote access sessions have been established. The ideal user actions may be recorded by the remote access server 106 during the historical remote access sessions. In an example, the pre-defined malicious user activity data 218 may be data including malicious user actions that are typically performed and executed by malicious users for executing malicious attempts or gaining unauthorized access within the OT network. In an example, the pre-defined malicious user activity data 218 may be obtained based on technical domain knowledge and publicly available information on malicious activities.

In operation, for enabling detection of unfamiliar user activities, the model training engine 214 of the remote access session monitoring unit 104 may be configured to obtain an activity monitoring model. The unfamiliar user activities may include unfamiliar actions that are typically not executed by a user while performing a particular activity in an authentic manner during a remote access session. The particular activity may be an activity for which the user had established the remote access session. Examples of the particular activity may include, but are not limited to, investigation procedure for looking into a sudden drop in production, investigation procedure for looking into a potential cyber-security breach, and routine maintenance or unplanned activities such as such as patching, hardening and log collection.

Further, for enabling detection of malicious user activities, the model training engine 214 of the remote access session monitoring unit 104 may be configured to obtain a malicious activity detection model. The malicious user activities may be malicious actions that are known to be performed for implementing a cyber-attack on the OT network during a remote access session.

For obtaining the activity monitoring model, the model training engine 214 may obtain historical ideal user activity data. In an example, the historical ideal user activity data may be obtained from the remote access server 106. The historical ideal user activity data may be indicative of different ideal user actions for performing a particular activity. The different ideal user actions may, for example, be actions that are typically performed by an authentic user for performing the particular activity. For example, actions typically performed by an authentic user for performing patching may be obtained. Accordingly, for different type of activities, different ideal user actions may be obtained.

Subsequently, the model training engine 214 may analyze the historical ideal user activity data to obtain the activity monitoring model. In an example, the model training engine 214 may analyze the historical ideal user activity data using a machine learning model to obtain the activity monitoring model. Thus, the activity monitoring model is trained to detect unfamiliar user actions by identifying that such user action is not typically performed while performing the particular activity. In an example, the activity monitoring model may refine itself over time while performing the detection of the unfamiliar user actions in various remote access sessions based on feedback for the detection.

For obtaining the malicious activity detection model, the model training engine 214 may obtain pre-defined malicious user activity data. The pre-defined malicious user activity data may be indicative of different malicious user actions performable during the remote access session. For example, an example malicious user action may be actions performed by a user while execute a malicious command through an application. In an example, the pre-defined malicious user activity data may be obtained based on pre-defined compliance rules formed by the organization, pre-defined regulatory or custom policies formed by the organization, information such as cybersecurity standards, guidelines, and best practices suggested by National Institute of Standards and Technology (NIST), and information available from open resources that describe the behaviors and methods of cyber adversaries.

Subsequently, the model training engine 214 may analyze the pre-defined malicious user activity data to obtain the malicious activity detection model. In an example, the model training engine 214 may analyze the pre-defined malicious user activity data using a machine learning model to obtain the malicious activity detection model. Thus, the malicious activity detection model is trained to identify whether a particular user action is malicious or not. In an example, the malicious activity detection model may refine itself over time while performing the detection of the malicious user actions in various remote access sessions based on feedback for the detection.

Now, for newly establishing a remote access session, a particular user, that intends to obtain remote access to an OT network of an organizational site 108 for performing a particular activity, may use the user device 110. The user may use the user device 110 to transmit a remote access authorization request to a site server 204 of the organizational site 108. The remote access authorization request may include information regarding the user and the site assets 206 which the user intends to remotely access. The remote access authorization request may further include information regarding the particular activity for which the user needs to remotely access the OT network.

The site server 204 may receive the remote access authorization request from the user device 110. Upon successful authentication of the particular user and the user device 110, the site server 204 may allow the user device 110 to remotely access the OT network of the organizational site 108 for performing the particular activity. In an example, the site server 204 may transmit a remote access grant notification to the user device 110. The remote access grant notification may be an acknowledgment that the user device 110 is allowed to remotely access the OT network. In an example, the remote access grant notification may specify a pre-determined time period for which the user device 110 is allowed to remotely access the OT network. The pre-determined time period may depend on the particular activity. For example, if the particular activity, such as patching usually takes upto 6 hours, then the site server 204 may allow the user device 110 to remotely access the OT network only for 6 hours.

Once the user device 110 receives the remote access grant notification, the user may use the user device 110 to transmit a session initiation request to the remote access server 106 for initiating a remote access session for performing the particular activity.

Upon receiving the session initiation request, the remote access server 106 may check if the session initiation request is authentic. In an example, the remote access server 106 may communicate with the site server 204 to check if the session initiation request is authentic. Upon successful authentication, the remote access server 106 may establish the remote access session between the user device 110 and the OT network.

Once the remote access session is established, the user may use the user device 110 to remotely perform the particular activity. The remote access server 106 may record and store the actions executed at the user device 110 during the remote access session. Examples of the actions executed at the user device 110 may include, but are not limited to, movement of a mouse locally on the user device 110, keystrokes pressed on a keyboard of the user device 110, and transfer of files between the user device 110 and the OT network. The remote access server 106 may compile the actions into user activity data and transmit the user activity data to the remote access session monitoring unit 104 for monitoring of the actions. In an example, the remote access server 106 may transmit the user activity data in real-time or after pre-defined periodic intervals. In an example, the remote access server 106 may transmit the user activity data without a request from the remote access session monitoring unit 104. In another example, the remote access server 106 may transmit the user activity data upon receiving a request for the same from the remote access session monitoring unit 104.

The communication module 114 of the remote access session monitoring unit 104 may receive the user activity data recorded in relation to the remote access session. In an example, the user activity data may be received in the form of digital signals. The user activity data may be indicative of the actions executed at the user device 110 during the remote access session. In an example, in addition to the actions recorded by the remote access server 106, the user activity data may include site data. The site data may be received from the site server 204. The site data may be indicative of the changes occurring at the organizational site 108 due to the actions executed by the user during the remote access session. For example, the actions executed by the user may be affecting an operational efficiency of the site asset 206.

Subsequently, the processing engine 120 of the remote access session monitoring unit 104 may implement the activity monitoring model to process the user activity data. The user activity data may be processed to ascertain occurrence of an unfamiliar activity event during the remote access session. The unfamiliar activity event may have no association to the particular activity. For example, if the particular user has established the remote access session for performing patching for a software, the activity monitoring model may be able to detect if the particular user performs any action that is not typically performed while performing patching.

The processing engine 120 may further utilize the malicious activity detection model to analyze the user activity data. The user activity data may be analyzed to ascertain occurrence of a malicious activity event during the remote access session. The malicious activity event may include occurrence of at least one of the malicious user actions during the remote access session. For example, the malicious activity detection model may detect if the particular user is executing a malicious command through any software application. In an example, the user activity data may be real-time user activity data indicative of the actions executed at the user device 110 at a particular time during the remote access session. In another example, the user activity data may be past data indicative of the actions executed at the user device 110 during a pre-defined duration of the remote access session. The pre-defined duration of the remote access session may either be entire duration of the remote access session or a subset of the entire duration of the remote access session.

Upon ascertaining occurrence of the unfamiliar activity event during the remote access session, the OT security engine 122 of the remote access session monitoring unit 104 may initiate one or more preventive actions. In an example, one preventive action can be to generate an alert notification for transmission to a supervisor of the organization on the supervisor device 202 so that the supervisor can take an appropriate measure for countering the effect of the unfamiliar activity event. During real-time monitoring of the user activity data, an exemplary preventive action may be initiating immediate termination of the remote access session.

For instance, when the user activity data is the real-time user activity data, the OT security engine 122 may generate a session termination signal upon ascertaining occurrence of the unfamiliar activity event or the malicious activity event. The communication module 114 may transmit the session termination signal to the remote access server 106 through which the remote access session is established. The session termination signal may be to initiate immediate termination of the remote access session. In addition or alternatively, when the user activity data is the real-time user activity data, the OT security engine 122 may generate an alert notification for transmission to a supervisor on the supervisor device 202. The alert notification may be indicative of at least one of the unfamiliar activity event and the malicious activity event that occurred at the particular time during the remote access session. Upon receiving the session termination signal from the remote access session monitoring unit 104, the remote access server 106 may immediately terminate the remote access session. Immediate termination of the remote access session inhibits the particular user from executing any further unfamiliar or malicious actions within the OT network.

In another instance, when the user activity data is the past data, the OT security engine 122 may generate an alert notification upon ascertaining occurrence of the unfamiliar activity event or the malicious activity event. The alert notification may indicate at least one of the unfamiliar activity event and the malicious activity event that occurred during the remote access session.

In one example, the communication module 114 may transmit the alert notification to a supervisor on the supervisor device 202. Upon receiving the alert notification on the supervisor device 202, the supervisor may take an appropriate measure to counter the effect of the unfamiliar activity event and the malicious activity event. As a result, the remote access session monitoring unit 104 prevents occurrence of any undesired event due to the unfamiliar or malicious activity, and prevents the organization from safety hazards and covering expenses which would have otherwise been required to be covered in case of any undesired event.

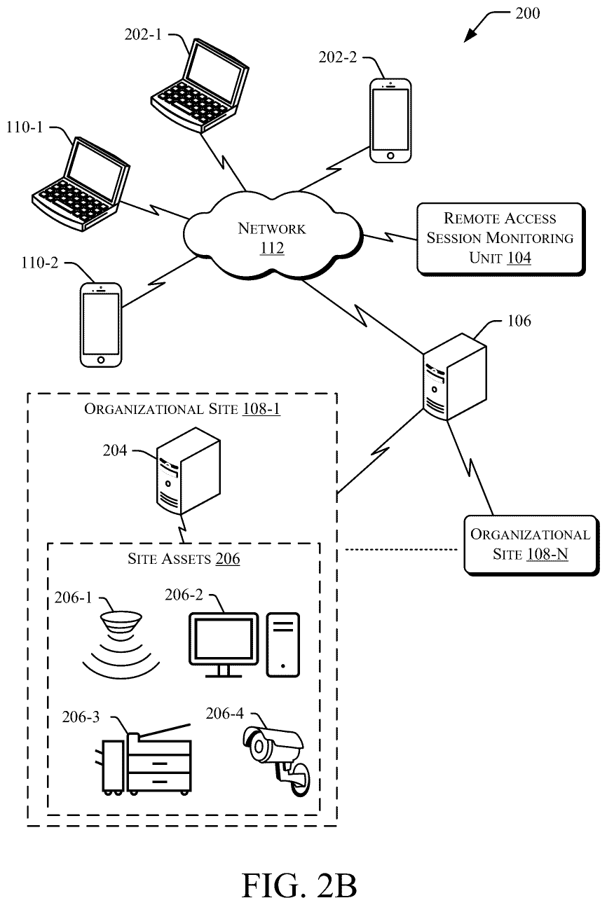

FIG. 3 illustrates a simplified block diagram 300 illustrating communication links 302, 304, 306, 308, 310, 312, and 314 established between various components of the computing environment 200 of FIG. 2A and FIG. 2B during monitoring of a remote access session 316, according to an example. For the explanation of FIG. 3, it is considered that the user intends to remotely access the site asset 206-1 through the remote access session 316.

The communication links 302, 304, 306, 308, 310, 312, and 314 may be a wireless link, a wired link, or a combination thereof. In an example, for communication, one or more of the communication links 302, 304, 306, 308, 310, 312, and 314 may be established over the network 112 explained with reference to FIG. 1.

In an example, a first communication link 302 may be used by the user device 110 and the site server 204 to transmit or receive data or signals prior to establishment of the remote access session 316. For example, the first communication link 302 may be used for transmission or reception of the remote access authorization request and the remote access grant notification, explained with reference to FIG. 2A and FIG. 2B.

In an example, a second communication link 304 may be used by the user device 110 and the remote access server 106 to transmit or receive data or signals for establishment of the remote access session 316. In an example, the second communication link 304 may be used by the user device 110 and the remote access server 106 for remotely accessing an OT network of an organization after the remote access session 316 has been established.

In an example, a third communication link 306 may be used by the remote access server 106 and the site server 204 to transmit or receive data or signals for authenticating the user and the user device 110 for establishment of the remote access session 316. In an example, the third communication link 306 may be used by the remote access server 106 and the site server 204 to transmit or receive data or signals in relation to the user actions that are to be executed during the remote access session 316.

In an example, a fourth communication link 308 may be used by the site server 204 and the site asset 206-1 to transmit or receive data or signals for controlling and supervising various industrial processes within the OT network. In an example, the fourth communication link 308 may be used by the site server 204 and the site asset 206-1 to transmit or receive data or signals in relation to the user actions that are to be executed during the remote access session 316.

In an example, a fifth communication link 310 may be used by the remote access server 106 and the remote access session monitoring unit 104 to transmit or receive data or signals for monitoring the remote access session 316. In an example, the fifth communication link 310 may be used by the remote access server 106 and the remote access session monitoring unit 104 to transmit or receive data or signals for implementing the preventive actions upon ascertaining occurrence of the unfamiliar activity event or the malicious activity event during the remote access session 316. In an example, the fifth communication link 310 may be used by the remote access server 106 and the remote access session monitoring unit 104 to transmit or receive data or signals for training of the activity monitoring model. For example, the fifth communication link 310 may be used to transmit or receive the user activity data, the historical ideal user activity data, and the session termination signal, explained with reference to FIG. 2A and FIG. 2B.

In an example, a sixth communication link 312 may be used by the site server 204 and the remote access session monitoring unit 104 to transmit or receive data or signals for enabling detection of the malicious user activity during the remote access session 316. In an example, the sixth communication link 312 may be used by the remote access server 106 and the remote access session monitoring unit 104 to transmit or receive data or signals for training of the malicious activity detection model. For example, the sixth communication link 312 may be used to transmit or receive the user activity data, the site data, and the pre-defined malicious user activity data, explained with reference to FIG. 2A and FIG. 2B.

In an example, a seventh communication link 314 may be used by the remote access session monitoring unit 104 to transmit data or signals for informing the supervisor of the unfamiliar or malicious activities that occurred during the remote access session 316. For example, the seventh communication link 314 may be used to transmit the alert notification, explained with reference to FIG. 2A and FIG. 2B.

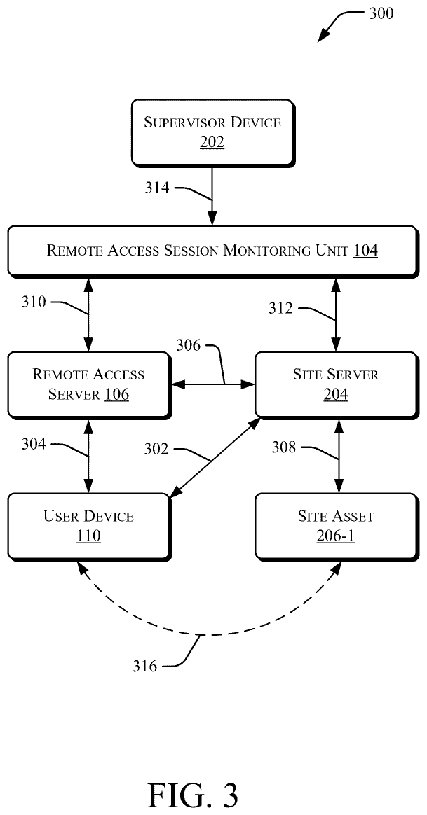

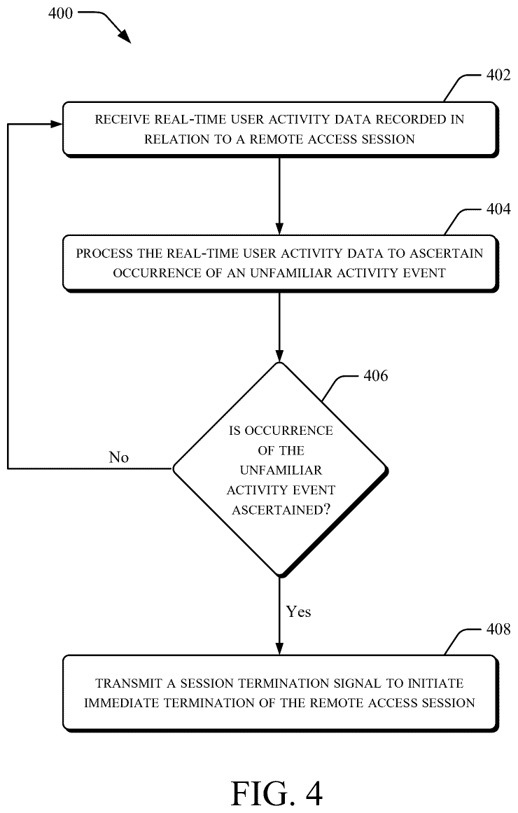

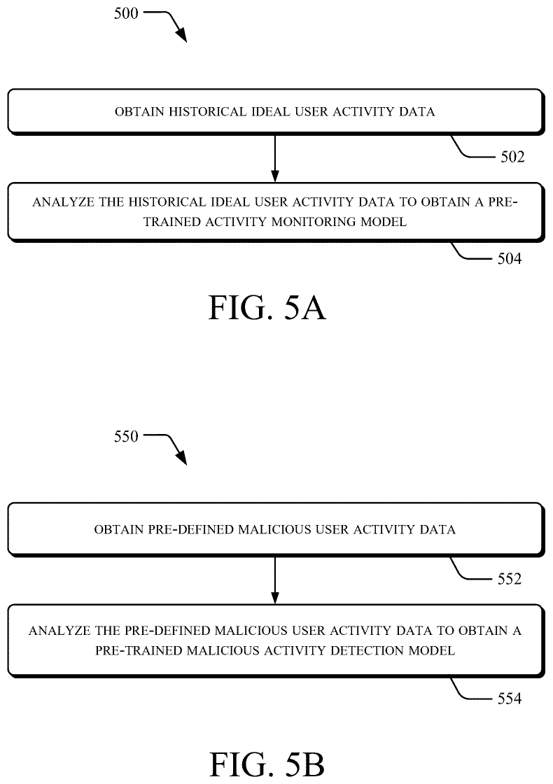

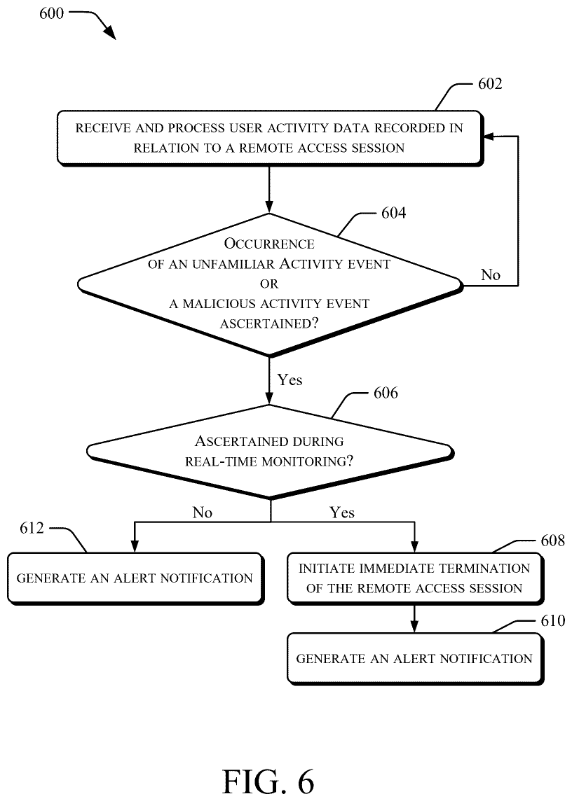

FIG. 4, FIG. 5A, FIG. 5B, and FIG. 6 illustrate example methods 400, 500, 550, and 600, respectively, for monitoring a remote access session. The order in which the methods are described is not intended to be construed as a limitation, and any number of the described method blocks may be combined in any order to implement the methods, or an alternative method. Further, the methods 400, 500, 550, and 600 may be implemented by processing resource or computing device(s) through any suitable hardware, non-transitory machine-readable instructions, or combination thereof.

It may also be understood that methods 400, 500, 550, and 600 may be performed by programmed computing devices, such as the remote access session monitoring unit 104, as depicted in FIG. 1 to FIG. 3. Furthermore, the methods 400, 500, 550, and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the methods 400, 500, 550, and 600 are described below with reference to the remote access session monitoring unit 104 and the system 102 as described above with reference to FIG. 1 to FIG. 3; other suitable systems for the execution of these methods may also be utilized. Additionally, implementation of the methods 400, 500, 550, and 600 is not limited to such examples.

FIG. 4 illustrates the method 400 for monitoring a remote access session, according to an example.

At block 402, real-time user activity data may be received from a remote access server, say the remote access server 106. The real-time user activity data may be recorded in relation to the remote access session, say the remote access session 316, established with the remote access server by a particular user for performing a particular activity. Examples of the particular activity may include, but are not limited to, investigation procedure for looking into a sudden drop in production, investigation procedure for looking into a potential cyber-security breach, and routine maintenance or unplanned activities such as such as patching, hardening and log collection. In an example, the remote access session may be established through a user device, say the user device 110. The remote access session may be established to remotely access an operational technology (OT) network at an organizational site for performing the particular activity. The real-time user activity data may be indicative of actions executed at the user device at a particular time during the remote access session. Examples of the actions executed at the user device may include, but are not limited to, movement of a mouse locally on the user device, keystrokes pressed on a keyboard of the user device, and transfer of files between the user device and the OT network.

At block 404, the real-time user activity data may be processed to ascertain occurrence of an unfamiliar activity event at the particular time. In an example, the real-time user activity data may be processed utilizing an activity monitoring model. The occurrence of the unfamiliar activity event may be ascertained when the actions have no association to the particular activity. For example, if the particular user has established the remote access session for performing patching for a software, the activity monitoring model may be able to detect if the particular user performs any action that is not typically performed while performing patching.

At block 406, it can be checked whether occurrence of the unfamiliar activity event is ascertained or not. If the unfamiliar activity event is not ascertained, the method may move back to block 402 and the real-time user activity data may be continuously received and processed.

Upon ascertaining occurrence of the unfamiliar activity event, at block 408, a session termination signal may be transmitted to the remote access server. The session termination signal may be transmitted to initiate immediate termination of the remote access session. Immediate termination of the remote access session inhibits the particular user from executing any further unfamiliar or malicious actions within the OT network. Thus, the remote access session monitoring unit 104 may efficiently and quickly detect unfamiliar activities that may be malicious and prevent the OT network from a cyber-attack.

FIG. 5A illustrates the method 500 for training of a machine learning model for detecting unfamiliar user activities during a remote access session, according to an example. By training the machine learning model, an activity monitoring model may be obtained that enables detection of the unfamiliar user activities. The unfamiliar user activities may be unfamiliar actions that are typically not executed by a user while performing a particular activity in an authentic manner during a remote access session. The particular activity may be an activity for which the user established the remote access session. Examples of the particular activity may include, but are not limited to, investigation procedure for looking into a sudden drop in production, investigation procedure for looking into a potential cyber-security breach, and routine maintenance or unplanned activities such as such as patching, hardening and log collection.

At block 502, historical ideal user activity data may be obtained. In an example, the historical ideal user activity data may be obtained from a remote access server, say the remote access server 106. The historical ideal user activity data may be indicative of different ideal user actions for performing the particular activity. The different ideal user actions may, for example, be actions that are typically performed by an authentic user for performing the particular activity. For example, actions typically performed by an authentic user for performing patching may be obtained. Accordingly, for different type of activities, different ideal user actions may be obtained.

At block 504, the historical ideal user activity data may be analyzed to obtain the activity monitoring model. In an example, the historical ideal user activity data may be analyzed using the machine learning model. Thus, the activity monitoring model is trained to detect unfamiliar user actions by identifying that such user action is not typically performed while performing the particular activity. In an example, the activity monitoring model may refine itself over time while performing the detection of the unfamiliar user actions in various remote access sessions based on feedback for the detection.

FIG. 5B illustrates the method 550 for training of a machine learning model for detecting malicious user activities during a remote access session, according to an example. By training the machine learning model, a malicious activity detection model may be obtained that enables detection of the malicious user activities. The malicious user activities may be malicious actions that are known to be performed for implementing a cyber attack on the OT network during a remote access session.

At block 552, pre-defined malicious user activity data may be obtained. The pre-defined malicious user activity data may be indicative of different malicious user actions performable during the remote access session. For example, an example malicious user action may be actions performed by a user while execute a malicious command through an application. In an example, the pre-defined malicious user activity data may be obtained based on pre-defined compliance rules formed by the organization, pre-defined regulatory or custom policies formed by the organization, information such as cybersecurity standards, guidelines, and best practices suggested by National Institute of Standards and Technology (NIST), and information available from open resources that describe the behaviors and methods of cyber adversaries.

At block 554, the pre-defined malicious user activity data may be analyzed to obtain a malicious activity detection model. In an example, the pre-defined malicious user activity data may be analyzed using the machine learning model. Thus, the malicious activity detection model is trained to identify whether a particular user action is malicious or not. In an example, the malicious activity detection model may refine itself over time while performing the detection of the malicious user actions in various remote access sessions based on feedback for the detection.

FIG. 6 illustrates the method 600 for monitoring a remote access session, according to an example.

At block 602, user activity data recorded in relation to the remote access session, say the remote access session 316, may be received and processed. In an example, the user activity data may be received from a remote access server, say the remote access server 106. In an example, the user activity data may be received in the form of digital signals. In an example, the remote access session may be established by a particular user for performing a particular activity. Examples of the particular activity may include, but are not limited to, investigation procedure for looking into a sudden drop in production, investigation procedure for looking into a potential cyber-security breach, and routine maintenance or unplanned activities such as such as patching, hardening and log collection. In an example, the remote access session may be established through a user device, say the user device 110. In an example, the remote access session may be established with the remote access server. The remote access session may be established to remotely access an operational technology (OT) network at an organizational site for performing the particular activity.

In an example, the user activity data may be indicative of actions executed at the user device during the remote access session. Examples of the actions executed at the user device may include, but are not limited to, movement of a mouse locally on the user device, keystrokes pressed on a keyboard of the user device, and transfer of files between the user device and the OT network. In an example, the user activity data may be real-time user activity data indicative of the actions executed at the user device at a particular time during the remote access session. In another example, the user activity data may be past data indicative of the actions executed at the user device during a pre-defined duration of the remote access session. The pre-defined duration of the remote access session may either be entire duration of the remote access session or a subset of the entire duration of the remote access session.

In an example, in addition to the actions recorded by the remote access server, the user activity data may include site data. The site data may be received from a site server, say the site server 204. The site data may be indicative of the changes occurring at the organizational site, say the organizational site 108, due to the actions executed by the user during the remote access session. For example, the actions executed by the user may be affecting an operational efficiency of a site asset, say the site asset 206.

In an example, the user activity data may be processed to ascertain occurrence of an unfamiliar activity event during the remote access session. In an example, the user activity data may be processed utilizing an activity monitoring model. The unfamiliar activity event may have no association to the particular activity. For example, if the particular user has established the remote access session for performing patching for a software, the activity monitoring model may be able to detect if the particular user performs any action that is not typically performed while performing patching.

In addition or alternatively, the user activity data may be analyzed to ascertain occurrence of a malicious activity event during the remote access session. In an example, the user activity data may be analyzed utilizing the malicious activity detection model. The malicious activity event may include occurrence of at least one of the malicious user actions during the remote access session. For example, the malicious activity detection model may detect if the particular user is executing a malicious command through any software application. In an example, the malicious activity detection model and the activity monitoring model may be implemented independent of each other to detect the malicious activities and the unfamiliar activities, respectively.

At block 604, it can be checked whether occurrence of the unfamiliar activity event or the malicious activity event is ascertained or not. If occurrence of any of the unfamiliar activity event and the malicious activity event is not ascertained, the method may move back to block 602 and the user activity data may be continuously received and processed.

Upon ascertaining occurrence of at least one of the unfamiliar activity event or the malicious activity event, at block 606, it can be checked whether the occurrence of the unfamiliar activity event or the malicious activity event is ascertained during real-time monitoring or not. In other words, it can be checked whether the user activity data is the real-time user activity data or the user activity data is the past data.

When the user activity data is the real-time user activity data, at block 608, immediate termination of the remote access session may be initiated. For initiating the termination of the remote access session, a session termination signal may be generated. Further, the session termination signal may be transmitted to the remote access server through which the remote access session is established. The session termination signal may be to initiate immediate termination of the remote access session. Upon receiving the session termination signal, the remote access server may immediately terminate the remote access session. Immediate termination of the remote access session inhibits the particular user from executing any further unfamiliar or malicious actions within the OT network. In addition or alternatively, when the user activity data is the real-time

user activity data, at block 610, an alert notification may be generated for transmission to a supervisor on a supervisor device, say the supervisor device 202. The alert notification may be indicative of at least one of the unfamiliar activity event and the malicious activity event that occurred at the particular time during the remote access session.

When, at block 606, it is determined that the user activity data is the past data, an alert notification may be generated. The alert notification may indicate at least one of the unfamiliar activity event and the malicious activity event that occurred during the remote access session.

The alert notification may be transmitted to a supervisor on the supervisor device. Upon receiving the alert notification on the supervisor device, the supervisor may take an appropriate measure to counter the effect of the unfamiliar activity event and the malicious activity event. As a result, the method 600 prevents occurrence of any undesired event due to the unfamiliar or malicious activity, and prevents the organization from safety hazards and covering expenses which would have otherwise been required to be covered in case of any undesired event.

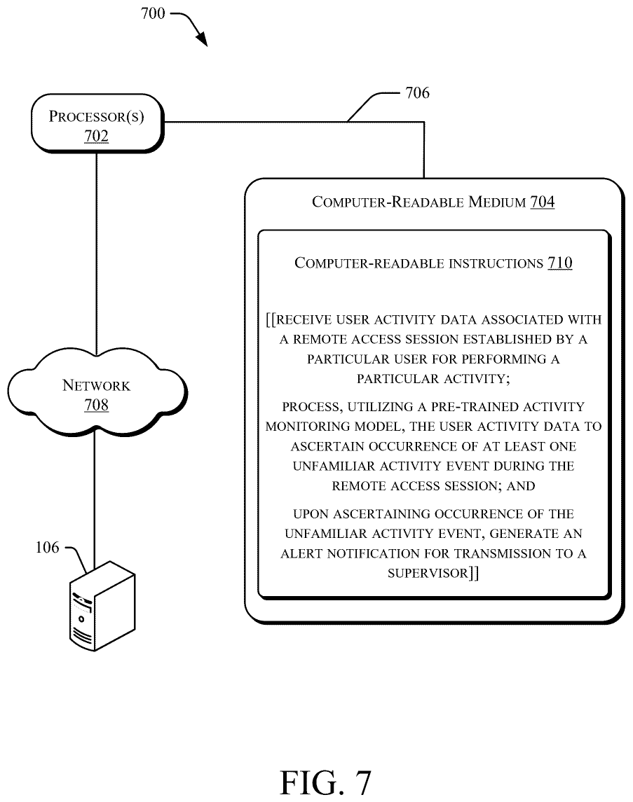

FIG. 7 illustrates a computing environment 700 implementing a non-transitory computer-readable medium for monitoring a remote access session, according to an example. In an example, the computing environment 700 includes processor(s) 702 communicatively coupled to a non-transitory computer-readable medium 704 through a communication link 706. In one example, the communication link 706 may be similar to the network 112, as described in conjunction with the preceding figures. In an example implementation, the computing environment 700 may be for example, the communication environment 100 or the communication environment 200. In an example, the processor(s) 702 may have one or more processing resources for fetching and executing computer-readable instructions from the non-transitory computer-readable medium 704. The processor(s) 702 and the non-transitory computer-readable medium 704 may be implemented, for example, in the system 102 or the remote access session monitoring unit 104 (as has been described in conjunction with the preceding figures).

The non-transitory computer-readable medium 704 may be, for example, an internal memory device or an external memory device. In an example implementation, the communication link 706 may be a network communication link. The processor(s) 702 and the non-transitory computer-readable medium 704 may also be communicatively coupled to the remote access server 106 over a network 708. The network 708 may be similar to the network 112 described in conjunction with the preceding figures.

In an example implementation, the non-transitory computer-readable medium 704 may include a set of computer-readable instructions 710 which may be accessed by the processor(s) 702 through the communication link 706. Referring to FIG. 7, in an example, the non-transitory computer-readable medium 704 may include instructions 710 that may cause the processor(s) 702 to receive user activity data associated with a remote access session. In an example, the user activity data may be received from the remote access server 106. In an example, the user activity data may be received in the form of digital signals. The remote access session may be established by a particular user for performing a particular activity. Examples of the particular activity may include, but are not limited to, investigation procedure for looking into a sudden drop in production, investigation procedure for looking into a potential cyber-security breach, and routine maintenance or unplanned activities such as such as patching, hardening and log collection. The remote access session may be established, through a user device, say the user device 110, to remotely access an operational technology (OT) network at an organizational site, say the organizational site 108, for performing the particular activity.

In an example, the user activity data may be indicative of actions executed at the user device during the remote access session. Examples of the actions executed at the user device may include, but are not limited to, movement of a mouse locally on the user device, keystrokes pressed on a keyboard of the user device, and transfer of files between the user device and the OT network. In an example, the user activity data may be past data indicative of the actions executed at the user device during a pre-defined duration of the remote access session. The pre-defined duration of the remote access session may either be entire duration of the remote access session or a subset of the entire duration of the remote access session. In an example, in addition to the actions recorded by the remote access server, the user activity data may include site data. The site data may be received from a site server, say the site server 204. The site data may be indicative of the changes occurring at the organizational site due to the actions executed by the user during the remote access session. For example, the actions executed by the user may be affecting an operational efficiency of a site asset, say the site asset 206.

In an example, the instructions 712 may cause the processor(s) 702 to process the user activity data to ascertain occurrence of at least one unfamiliar activity event during the remote access session. In an example, the user activity data may be processed utilizing an activity monitoring model. The unfamiliar activity event may have no association to the particular activity. For example, if the particular user has established the remote access session for performing patching for a software, the activity monitoring model may be able to detect if the particular user performs any action that is not typically performed while performing patching.

In an example, for obtaining the activity monitoring model, the instructions 712 may cause the processor(s) 702 to obtain historical ideal user activity data. In an example, the historical ideal user activity data may be obtained from the remote access server 106. The historical ideal user activity data may be indicative of different ideal user actions for performing the particular activity. The different ideal user actions may, for example, be actions that are typically performed by an authentic user for performing the particular activity. For example, actions typically performed by an authentic user for performing patching may be obtained. Accordingly, for different type of activities, different ideal user actions may be obtained.

Further, the instructions 712 may cause the processor(s) 702 to analyze the historical ideal user activity data to obtain the activity monitoring model. In an example, the historical ideal user activity data may be analyzed for training a machine learning model, thereby obtaining the activity monitoring model. Thus, the activity monitoring model is trained to detect unfamiliar user actions by identifying that such user action is not typically performed while performing the particular activity. In an example, the activity monitoring model may refine itself over time while performing the detection of the unfamiliar user actions in various remote access sessions based on feedback for the detection.

Upon ascertaining occurrence of the unfamiliar activity event, in an example, the instructions 712 may cause the processor(s) 702 to generate an alert notification for transmission to a supervisor. The alert notification may be indicative of the at least one unfamiliar activity event that occurred during the remote access session. The alert notification may be transmitted to a supervisor on the supervisor device. Upon receiving the alert notification on the supervisor device, the supervisor may take an appropriate measure to counter the effect of the unfamiliar activity event and the malicious activity event.

In an example, for enabling detection of malicious user activities, a malicious activity detection model may be obtained. The malicious user activities may be malicious actions that are known to be performed for implementing a cyber-attack on the OT network during a remote access session. For obtaining the malicious activity detection model, the instructions 712 may cause the processor(s) 702 to obtain pre-defined malicious user activity data. The pre-defined malicious user activity data may be indicative of different malicious user actions performable during the remote access session. For example, an example malicious user action may be actions performed by a user while execute a malicious command through an application. In an example, the pre-defined malicious user activity data may be obtained based on pre-defined compliance rules formed by the organization, pre-defined regulatory or custom policies formed by the organization, information such as cybersecurity standards, guidelines, and best practices suggested by National Institute of Standards and Technology (NIST), and information available from open resources that describe the behaviors and methods of cyber adversaries.

Subsequently, the instructions 712 may cause the processor(s) 702 to analyze the pre-defined malicious user activity data to obtain the malicious activity detection model. In an example, the pre-defined malicious user activity data may be analyzed using a machine learning model to obtain the malicious activity detection model. Thus, the malicious activity detection model is trained to identify whether a particular user action is malicious or not. In an example, the malicious activity detection model may refine itself over time while performing the detection of the malicious user actions in various remote access sessions based on feedback for the detection.

Upon receiving the user activity data, the instructions 712 may cause the processor(s) 702 to analyze the user activity data to ascertain occurrence of a malicious activity event during the remote access session. The user activity data may be analyzed utilizing the malicious activity detection model. The malicious activity event may include occurrence of at least one of the malicious user actions during the remote access session. For example, the malicious activity detection model may detect if the particular user is executing a malicious command through any software application.

Upon ascertaining the malicious activity event, the instructions 712 may cause the processor(s) 702 to generate another alert notification. The another alert notification may indicate the malicious activity event that occurred during the remote access session upon ascertaining occurrence of the malicious activity event. The another alert notification may be transmitted to a supervisor on a supervisor device. In an example, the another alert notification may be incorporated within the alert notification generated for the unfamiliar activity event when both the unfamiliar activity event and the malicious activity event are ascertained. Upon receiving the alert notification or the another alert notification on the supervisor device, the supervisor may take an appropriate measure to counter the effect of the unfamiliar activity event and the malicious activity event.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a remote access session monitoring unit comprising:
a communication module to receive user activity data recorded in relation to a remote access session established by a particular user for performing a particular activity, the remote access session being established, through a user device, to remotely access an operational technology (OT) network at an organizational site for performing the particular activity, wherein the user activity data is indicative of actions executed at the user device during the remote access session;
a processing engine implementing an activity monitoring model to process the user activity data to ascertain occurrence of an unfamiliar activity event during the remote access session, wherein the unfamiliar activity event has no association to the particular activity; and
an OT security engine to initiate one or more preventive actions upon ascertaining occurrence of the unfamiliar activity event during the remote access session.

2. The system of claim 1, wherein the remote access session monitoring unit comprises a model training engine to:
obtain historical ideal user activity data, wherein the historical ideal user activity data is indicative of different ideal user actions for performing the particular activity; and
analyze the historical ideal user activity data to obtain the activity monitoring model.

3. The system of claim 1, wherein the user activity data is real-time user activity data indicative of the actions executed at the user device at a particular time during the remote access session.

4. The system of claim 3, wherein the one or more preventive actions include at least one of:
transmitting, to a remote access server, a session termination signal to initiate immediate termination of the remote access session, wherein the remote access session is established through the remote access server; and
generating an alert notification for transmission to a supervisor on a supervisor device, wherein the alert notification is indicative of the unfamiliar activity event that occurred at the particular time during the remote access session.

5. The system of claim 1, wherein the user activity data is indicative of the actions executed at the user device during a pre-defined duration of the remote access session.

6. The system of claim 5, wherein the one or more preventive actions include:
generating an alert notification indicating the unfamiliar activity event that occurred during the remote access session; and
transmitting the alert notification to a supervisor on a supervisor device.

7. The system of claim 1, wherein the remote access session monitoring unit comprises a model training engine to:
obtain pre-defined malicious user activity data, wherein the pre-defined malicious user activity data is indicative of different malicious user actions performable during the remote access session; and
analyze the pre-defined malicious user activity data to obtain a malicious activity detection model.

8. The system of claim 7, wherein the processing engine is to:
analyze, utilizing the malicious activity detection model, the user activity data to ascertain occurrence of a malicious activity event during the remote access session, wherein the malicious activity event includes occurrence of at least one of the malicious user actions during the remote access session.

9. The system of claim 8, wherein, for the user activity data being real-time user activity data indicative of the actions executed at the user device at a particular time during the remote access session, upon ascertaining occurrence of the malicious activity event, the OT security engine is to initiate at least one of:
generation of a session termination signal, for transmission to a remote access server, to initiate immediate termination of the remote access session, wherein the remote access session is established through the remote access server; and
generation of an alert notification for transmission to a supervisor on a supervisor device, wherein the alert notification is indicative of the malicious activity event that occurred at the particular time during the remote access session.

10. The system of claim 8, wherein, for the user activity data being indicative of the actions executed at the user device during a pre-defined duration of the remote access session,
upon ascertaining occurrence of the malicious activity event, the OT security engine is to generate an alert notification indicating the malicious activity event that occurred during the remote access session; and
the communication module is to transmit the alert notification to a supervisor on a supervisor device.

11. A method comprising:
receiving, from a remote access server, real-time user activity data recorded in relation to a remote access session established with the remote access server by a particular user for performing a particular activity, the remote access session being established, through a user device, to remotely access an operational technology (OT) network at an organizational site for performing the particular activity, wherein the real-time user activity data is indicative of actions executed at the user device at a particular time during the remote access session;
processing, utilizing an activity monitoring model, the real-time user activity data to ascertain occurrence of an unfamiliar activity event at the particular time, wherein the occurrence of the unfamiliar activity event is ascertained when the actions have no association to the particular activity; and
upon ascertaining occurrence of the unfamiliar activity event, transmitting, to the remote access server, a session termination signal to initiate immediate termination of the remote access session.

12. The method of claim 11, wherein the method comprises:
obtaining historical ideal user activity data, wherein the historical ideal user activity data is indicative of different ideal user actions for performing the particular activity; and
analyzing the historical ideal user activity data to obtain the activity monitoring model.

13. The method of claim 11, wherein the method comprises:
generating an alert notification indicating the unfamiliar activity event that occurred at the particular time during the remote access session; and
transmitting the alert notification to a supervisor on a supervisor device.

14. The method of claim 11, wherein the method comprises:
obtaining pre-defined malicious user activity data, wherein the pre-defined malicious user activity data is indicative of different malicious user actions performable during the remote access session; and
analyzing the pre-defined malicious user activity data to obtain a malicious activity detection model.

15. The method of claim 14, wherein the method comprises:
analyzing, utilizing the malicious activity detection model, the user activity data to ascertain occurrence of a malicious activity event during the remote access session, wherein the malicious activity event includes occurrence of at least one of the malicious user actions during the remote access session; and
generating an alert notification for transmission to a supervisor on a supervisor device upon ascertaining occurrence of the malicious activity event, wherein the alert notification is indicative of the malicious activity event that occurred at the particular time during the remote access session.

16. A non-transitory computer-readable medium comprising instructions for monitoring of a remote access session, the instructions being executable by a processing resource to:
receive user activity data associated with a remote access session established by a particular user for performing a particular activity, the remote access session being established, through a user device, to remotely access an operational technology (OT) network at an organizational site for performing the particular activity, wherein the user activity data is indicative of actions executed at the user device during the remote access session;
process, utilizing an activity monitoring model, the user activity data to ascertain occurrence of at least one unfamiliar activity event during the remote access session, wherein the unfamiliar activity event has no association to the particular activity; and
upon ascertaining occurrence of the unfamiliar activity event, generate an alert notification for transmission to a supervisor, wherein the alert notification is indicative of the at least one unfamiliar activity event that occurred during the remote access session.

17. The non-transitory computer-readable medium of claim 16, wherein the instructions are executable by the processing resource to:
obtain historical ideal user activity data, wherein the historical ideal user activity data is indicative of different ideal user actions for performing the particular activity; and
analyze the historical ideal user activity data to obtain the activity monitoring model.

18. The non-transitory computer-readable medium of claim 16, wherein the instructions are executable by the processing resource to:
obtain pre-defined malicious user activity data, wherein the pre-defined malicious user activity data is indicative of different malicious user actions performable during the remote access session; and
analyze the pre-defined malicious user activity data to obtain a malicious activity detection model.

19. The non-transitory computer-readable medium of claim 18, wherein the instructions are executable by the processing resource to:
analyze, utilizing the malicious activity detection model, the user activity data to ascertain occurrence of a malicious activity event during the remote access session, wherein the malicious activity event includes occurrence of at least one of the malicious user actions during the remote access session.

20. The non-transitory computer-readable medium of claim 19, wherein the instructions are executable by the processing resource to:
generate another alert notification indicating the malicious activity event that occurred during the remote access session upon ascertaining occurrence of the malicious activity event; and
transmit the another alert notification to a supervisor on a supervisor device.
